(19) United States
(12) Patent Application Publication
(10) Pub. No.: US 2004/0060932 A1
(43) Pub. Date: Apr. 1, 2004

(54) Microwave oven and method of controlling the same

(75) Inventor: Yun-Bong Chun, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-City (KR)

(21) Appl. No.: 10/310,833

(22) Filed: Dec. 6, 2002

(30) Foreign Application Priority Data
Sep. 26, 2002 (KR) 2002-58417

(51) Int. Cl. H05B 6/50; H05B 1/02

(52) U.S. Cl. 219/714; 219/490; 219/506

(57) ABSTRACT

A microwave oven and method are described wherein the microwave oven includes an interface unit interfacing with a plug and play drive to read out cooking information stored in the drive that does not necessitate a separate recognition device. The drive has a large storage capacity and a fast processing rate. The microwave oven also includes a display unit displaying the cooking information, a key input unit selecting one or more pieces of cooking information from the cooking information displayed on the display unit, and a control unit controlling the cooking information stored in the USB drive to be read out and displayed on the display unit through the interface unit, and controlling cooking on the basis of cooking information selected through the key input unit. The microwave oven conveniently and rapidly stores and executes various large-sized cooking information without an additional recognition device.

### CROSS-REFERENCE TO RELATED APPLICATION

This application claims the benefit of Korean Patent Application No. 2002-58417, filed Sep. 26, 2002, in the Korean Intellectual Property Office, the disclosure of which is incorporated herein by reference.

### BACKGROUND OF THE INVENTION

1. Field of the Invention

The present invention relates generally to a microwave oven and method of controlling the same, and more particularly to a microwave oven and method of controlling the oven conveniently and rapidly to provide various and large-sized cooking information to extend the range of cooking options of the microwave oven.

2. Description of the Related Art

In general, a microwave oven is a cooking apparatus that uses microwaves differently from a cooking apparatus that uses an external heating method using heat conduction, heat radiation or the like. A microwave oven that cooks food using microwaves is generally equipped in a body of the microwave with a memory in which cooking information is previously stored. The microwave oven carries out automatic cooking according to cooking information selected by a user from the previously stored cooking information, or manual cooking according to cooking information that the user sets directly.

Typically, due to a small capacity, a memory cannot store a large quantity of cooking information and also cannot periodically update current cooking information. To solve these problems, a memory pack in which a nonvolatile memory (such as an Electrically Erasable Programmable Read-Only Memory (EEPROM), a flash memory or the like) is contained is used as a portable storage unit. That is, the memory pack stores cooking information downloaded from the Internet in a computer connected to the Internet. The microwave oven then is inserted into a corresponding insertion hole of a microwave oven. Accordingly, the microwave oven recognizes the cooking information stored in the memory pack and carries out cooking in correspondence with the recognized cooking information, or updates cooking information stored in the microwave oven.

However, various dishes that can be prepared by a microwave oven have been developed and various recipes according to the various dishes have continuously increased. In addition, cooking information on the various dishes and the various recipes is produced in the form of audiovisual files to notify users effectively about the various dishes and the various recipes. For this reason, a storage capacity which the cooking information occupies is greatly increased. However, since a conventional memory pack is expensive relative to the storage capacity of the memory pack, use of the conventional memory pack in manufacturing a microwave oven results in increased cost.

Additionally, the conventional memory pack has a low processing rate in comparison with other portable storage units due to the use of a parallel data transmission method. Thus, the conventional memory pack is inconvenient since excessive time is required to communicate with a microwave oven.

Additionally, the conventional memory pack is inconvenient because a recognition program recognizing the memory pack and a power cable also need to be provided to offer the cooking information to the microwave oven.

### SUMMARY OF THE INVENTION

Accordingly, in order to solve the above and other problems, it is an aspect of the present invention to provide a microwave oven and method of controlling the same, which reads out cooking information stored in a USB drive that does not necessitate an additional recognition device, has a large storage capacity, a fast processing rate, and conveniently and rapidly stores and executes various cooking information desired by a user.

Another aspect of the present invention is to provide a microwave oven and method of controlling the same, wherein a user is allowed to carry out cooking easily according to cooking information and to store the cooking information after supplying the user with the cooking information in the form of image files.

Additional aspects and advantages of the invention will be set forth in part in the description which follows and, in part, will be clear from the description, or may be learned by practice of the invention.

The foregoing and other aspects of the present invention are achieved by providing an embodiment of the invention including a microwave oven that includes an interface unit interfacing with a Universal Serial Bus (USB) drive that stores a plurality of items of cooking information, a display unit which displays the cooking information, and a key input unit selecting one or more items of cooking information from the cooking information displayed on the display unit. The microwave oven further includes a control unit that controls the cooking information stored in the USB drive to be read out and displayed on the display unit through the interface unit and controls cooking on the basis of cooking information selected through the key input unit.

In addition, the foregoing and other aspects of the present invention are achieved by providing another embodiment of the invention including a method of controlling a microwave oven that includes: determining whether an USB drive storing a plurality of items of cooking information is electrically connected to the microwave oven; reading out and displaying the stored cooking information if the USB drive is connected to the microwave oven; determining whether one or more items of the displayed cooking information are selected by a user; displaying a cooking image and a recipe of the selected cooking information if the items of the displayed cooking information are selected; determining whether an execution command key or a storage command key is manipulated; carrying out cooking on the basis of the selected cooking information if the execution command key is manipulated; and storing the selected cooking information in an auxiliary memory if the storage command key is manipulated.

### BRIEF DESCRIPTION OF THE DRAWINGS

The above and other aspects and advantages of the present invention will become apparent and more readily appreciated from the following detailed description of the embodiments, taken in conjunction with the accompanying drawings of which:

FIG. 1 is a schematic diagram showing a use of a microwave oven in accordance with an embodiment of the present invention;

FIG. 2 is a control block diagram of a microwave oven in accordance with an embodiment of the present invention; and

FIG. 3 is a flowchart illustrating a microwave oven control process in accordance with an embodiment of the present invention.

### DETAILED DESCRIPTION OF THE EMBODIMENTS

Reference will now be made in detail to the present embodiment of the present invention, examples of which are illustrated in the accompanying drawings, wherein like reference numerals refer to like elements throughout. The embodiments are described below in order to explain the present invention by referring to the figures.

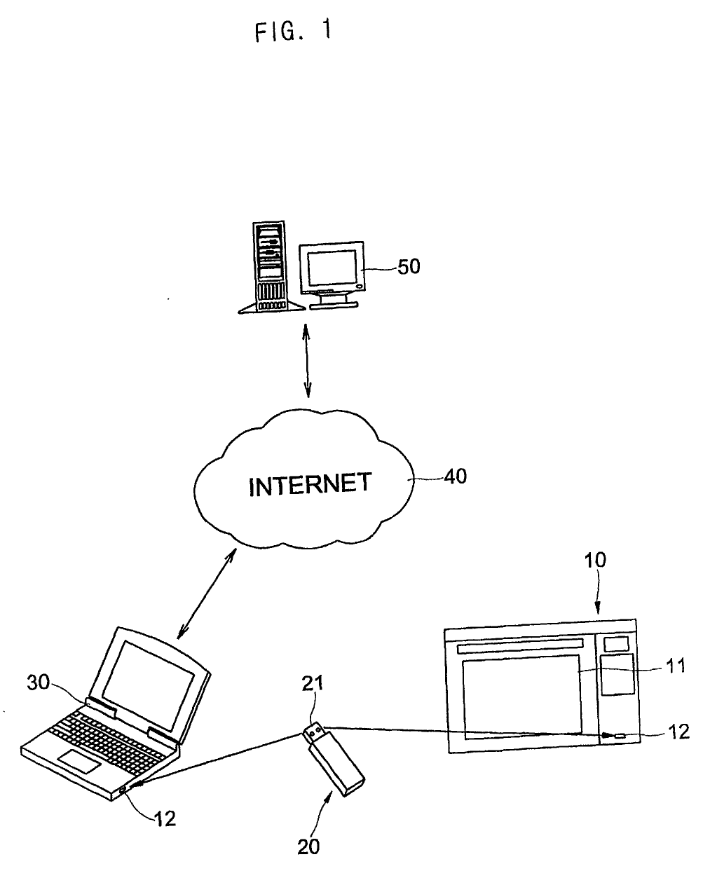

Hereinafter, an embodiment of the present invention is described in detail with reference to the accompanying the FIGS. 1 through 3. FIG. 1 is a schematic diagram showing a use of a microwave oven in accordance with the present invention. In the embodiment of the present invention shown in FIG. 1, a microwave oven 10 is detachably equipped with an USB drive 20 in which cooking information is stored. Accordingly, the microwave oven 10 can carry out cooking on a basis of the cooking information stored in the USB drive 20 and update cooking information stored in the microwave oven 10. Alternatively, a user may add new cooking information to the cooking information stored in the microwave oven 10 through the exchange of information with the USB drive 20. A USB port 12 is formed in the front of the oven body 11 of the microwave oven 10 to allow the USB drive 20 to be connected to the microwave oven 10 or to a computer 30.

Cooking information downloaded from a web server 50 on the Internet is supplied by the USB drive 20 to the microwave oven 10. The USB drive 20 is connected to the USB port 12 of the computer 30. The computer 30 is connected to the Internet 40 to be connected to a web server 50 on the Internet 40. The USB drive 20 downloads cooking information from the web server 50 and stores the cooking information. A USB connector 21 is formed in the USB drive 20 to be protruded in the longitudinal direction of the USB drive 20 to facilitate connecting the USB drive 20 to one of USB ports 12 formed in the computer 30 and the microwave oven 10.

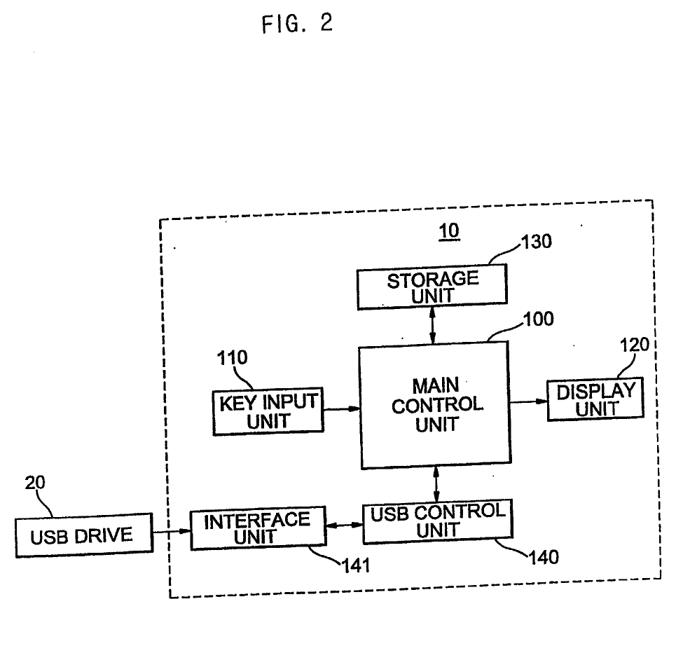

FIG. 2 is a control block diagram of a microwave oven in accordance with an embodiment of the present invention. In the embodiment of the present invention shown in FIG. 2, the microwave oven 10 includes a main control unit 100 that controls the overall operation of the microwave oven 10 and cooking information stored in the USB drive 20. The main control unit 100 is electrically connected at an input side to a key input unit 110 through which key commands are inputted from a user. In addition, the main control unit 100 is electrically connected at an output side to a display unit 120 that displays desired information. Also, the main control unit 100 is electrically connected at a combined input and output side to a storage unit 130. A control program, cooking information and various information needed to control the microwave oven 10 are have been stored previously in the storage unit 130. The control unit 100 can be a computer implementing a program which controls an operation of the microwave oven 10.

Meanwhile, the main control unit 100 is electrically connected at another combined input and output side to a USB control unit 140 that communicates with the main control unit 100. The USB control unit 140 reads out cooking information from the USB drive 20 in response to a control signal of the main control unit 100 and transmits the cooking information to the main control unit 100. The USB control unit 140 is electrically connected to an interface unit 141 to read out cooking information from the USB drive 20.

The key input unit 110 is equipped with separate command keys that at least store, delete, select, execute and read out cooking information stored in the USB drive 20. The interface unit 141 includes the USB port 12 connected to the USB connecter 21 of the USB drive 20.

While discussed in terms of a USB standard, it is understood that other standards, such as USB 2.0 or IEEE 1394, could be implemented in which the main control unit 100 is automatically able to recognize the attached drive using plug and play methods. For example, a plug and play drive such as a drive using the Universal Plug and Play (UPnP) standard may be utilized. When the plug and play drive is plugged into the microwave oven, the drive typically identifies itself, and the microwave oven then controls the drive. The microwave oven may be controlled by a computer wherein a computer-readable medium having computer-executable instructions stored thereon causes the computer to perform the method of controlling the microwave oven.

Hereinafter, the process of communicating with the USB drive 20, obtaining cooking information from the USB drive 20 and processing the cooking information is described.

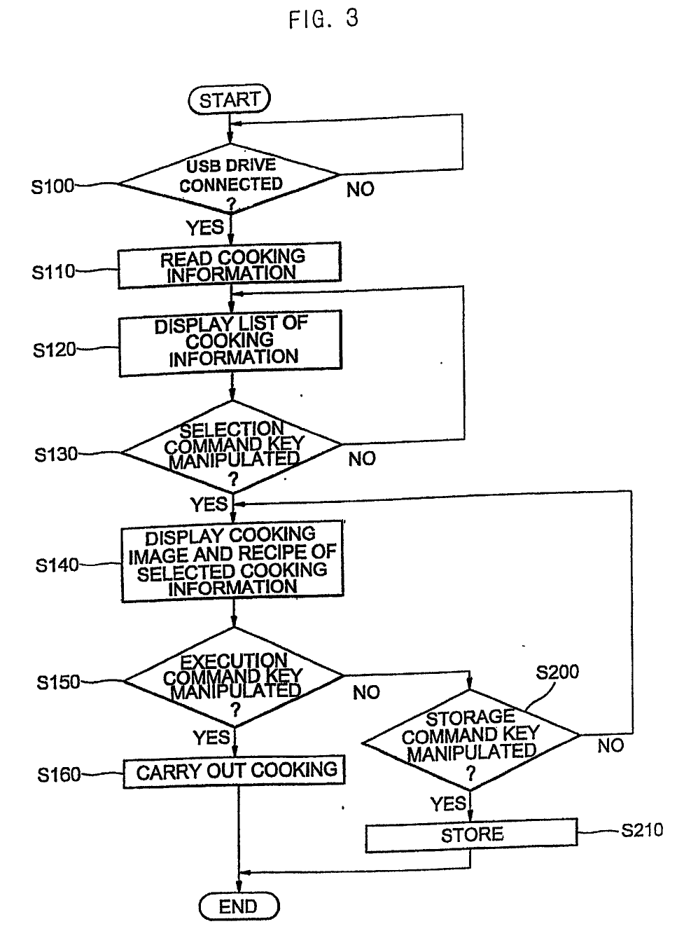

FIG. 3 is a flowchart illustrating one embodiment of a process of controlling a microwave oven in accordance with the present invention. First, a user downloads cooking information from the corresponding web server 50 through the computer 30 connected to the Internet 40, and stores the cooking information in the USB drive 20 connected to the USB port 12 of the computer 30. Thereafter, the user inserts the USB connector 21 of the USB drive 20 to the USB port 12 formed in the body 11 of the microwave oven 10. When the USB connector 21 is inserted to the body 11 of the microwave oven 10, the USB drive 20 is electrically connected to the interface unit 141 of the microwave oven 10. Accordingly, the USB control unit 140 of the oven body 11 can recognize the USB drive 20 electrically connected to the microwave oven 10.

Referring to FIG. 3, the main control unit 100 determines whether the USB drive 20 is electrically connected to the microwave oven 10 at operation S100. At this time, the control unit 100 determines whether the USB drive 20 is electrically connected to the microwave oven 10 by communication with the USB control unit 140.

If the USB drive 20 is electrically connected to the microwave oven 10 at operation S100, the main control unit 100 controls the USB control unit 140 to read out cooking information stored in the USB drive 20 through the interface unit 141 and to transmit the cooking information to the main control unit 100 at operation S110. In contrast, if the USB drive 20 is not electrically connected to the microwave oven 10 at operation S100, the main control unit 100 continuously determines whether the USB drive 20 is electrically connected to the microwave oven 10. In this case, the main control unit 100 may determine if the USB drive 20 is connected to the microwave oven 10 by a separate sensor or if the USB drive 20 is connected to the microwave oven 10 only when the key input unit 110 is manipulated.

The main control unit 100 allows a list of the cooking information stored in the USB drive 20 to be displayed on the display unit 120 at operation S120. Accordingly, the user searches for and selects desired cooking information from the list of the cooking information displayed on the display unit 120 by the manipulation of the key input unit 110. At operation S130, the main control unit 100 determines whether a selection command key of the key input unit 110 is manipulated to select the desired cooking information after displaying the list of the cooking information.

If the selection command key is manipulated to select the desired cooking information at operation S130, the main control unit 100 displays the cooking image and recipe of the selected cooking information on the display unit 120 at operation S140.

At operation S150, the main control unit 100 determines whether an execution command key of the key input unit 110 is manipulated to execute the selected cooking information after the cooking image and recipe of the selected cooking information are displayed. If the execution command key is executed at operation S150, the main control unit 100 carries out cooking according to the selected cooking information at operation S160.

In contrast, if the execution command key is not manipulated at operation S150, the main control unit 100 determines whether a storage command key of the key input unit 110 is manipulated to store the selected cooking information in the storage unit 130 disposed in the microwave oven 10 at operation S200. If the storage command key is not manipulated, the main control unit 100 returns to operation S140 and continuously displays the cooking image and recipe of the selected cooking information.

In contrast, if the storage command key is manipulated, the storage control unit 100 copies the selected cooking information and stores the selected cooking information in the storage unit 130 at operation S210. At this time, if the storage capacity of the storage unit 130 is insufficient, the main control unit 100 controls the display unit 120 to display a message instructing a user to delete some or all of the information stored in the storage unit 130 and to store the selected cooking information.

It is understood that the method shown in FIG. 3 can be implemented as a computer program readable by a computer and which is stored on a computer readable medium.

As described above in detail, the microwave oven of the present invention executes cooking information and stores the cooking information in an auxiliary memory of the microwave oven from the USB drive that does not necessitate a separate recognition device but has a large storage capacity and a fast processing rate, thus conveniently and rapidly executing a variety of cooking information desired by a user, updating stored cooking information, or adding new cooking information to the stored cooking information.

In addition, the microwave oven of the present invention allows a user to carry out cooking easily according to the cooking information and to store the cooking information by providing a user with the cooking information in the form of image files.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A microwave oven, comprising:
an interface unit interfacing with a Universal Serial Bus (USB) drive that stores a plurality of items of cooking information;
a display unit displaying the cooking information stored in the USB drive;
a cooking unit to supply microwaves for use in cooking items disposed in the microwave oven;
a key input unit selecting one or more items of cooking information from the cooking information displayed on the display unit; and
a control unit which controls the cooking information stored in the USB drive to be read out and displayed on the display unit through the interface unit, and controls the cooking unit on the basis of the cooking information selected through the key input unit.

2. The microwave oven as set forth in claim 1, further comprising a storage unit in which basic cooking information is previously stored,
wherein the control unit controls the selected item of cooking information selected through the key input unit to be stored in the storage unit.

3. The microwave oven as set forth in claim 2, wherein said key input unit is equipped with separate command keys that correspond to reading out, storage and execution of the cooking information stored in the USB drive.

4. The microwave oven as set forth in claim 1, wherein said cooking information is produced in the form of image files regarding cooking images, recipes and cooking orders.

5. A method of controlling a microwave oven, comprising:
determining whether a USB drive storing a plurality of items of cooking information is electrically connected to the microwave oven;
reading out and displaying the stored cooking information if the USB drive is connected to the microwave oven;
determining whether one or more items of the displayed cooking information are selected by a user;
displaying a cooking image and a recipe of the selected cooking information if the items of the displayed cooking information are selected;
determining if one of: an execution command key or a storage command key is manipulated; and
carrying out cooking on the basis of the selected cooking information if the execution command key is manipulated, and storing the selected cooking information in an auxiliary memory if the storage command key is manipulated.

6. (NEW) The method of claim 5, including unplugging the USB drive, connecting the USB drive to a computer to obtain additional items of cooking information, and uploading the additional items of cooking information.

7. (NEW) A microwave oven, comprising:
an interface unit interfacing with a plug and play drive that stores a plurality of items of cooking information;
a cooking unit to supply microwaves for use in cooking items disposed in the microwave oven; and
a control portion which controls the cooking information stored in the plug and play drive and controls cooking based on the cooking information.

8. (NEW) The microwave oven as set forth in claim 7, wherein the control portion includes a display unit to display the cooking information stored in the plug and play drive.

9. (NEW) The microwave oven as set forth in claim 8, wherein the control portion includes a key input unit to use to select one or more items of cooking information from the cooking information displayed on the display unit.

10. (NEW) The microwave oven as set forth in claim 9, further comprising a storage unit in which basic cooking information is previously stored,
wherein the control portion controls the selected item of cooking information selected through the key input unit to be stored in the storage unit.

11. (NEW) The microwave oven as set forth in claim 9, wherein said key input unit is equipped with separate command keys that correspond to reading out, storage and execution of the cooking information stored in the USB drive.

12. (NEW) The microwave oven as set forth in claim 7, wherein said cooking information is produced in the form of image files regarding cooking images, recipes and cooking orders.

13. (NEW) A microwave oven, comprising:
a removable plug and play drive having a memory storing a plurality of items of cooking information;
a cooking unit to supply microwaves for use in cooking items disposed in the microwave oven; and
a control system, removably coupled to the plug and play drive, controlling the cooking information stored in the plug and play drive and controlling cooking based on the cooking information.

14. (NEW) The microwave oven as set forth in claim 13, wherein the control system includes an interface unit interfacing with the plug and play drive.

15. (NEW) The microwave oven as set forth in claim 13, wherein the control system includes a display unit to display the cooking information.

16. (NEW) The microwave oven as set forth in claim 15, wherein the control system includes a key input unit to use to select one or more items of cooking information from the cooking information displayed on the display unit.

17. (NEW) The microwave oven as set forth in claim 16, further comprising a storage unit in which basic cooking information is previously stored,
wherein the control system controls the selected item of cooking information selected through the key input unit to be stored in the storage unit.

18. (NEW) The microwave oven as set forth in claim 16, wherein said key input unit is equipped with separate command keys that correspond to reading out, storage and execution of the cooking information stored in the plug and play drive.

19. (NEW) The microwave oven as set forth in claim 13, wherein said cooking information is produced in the form of image files regarding cooking images, recipes and cooking orders.

20. (NEW) A computer-readable medium having computer-executable instructions stored thereon for causing a computer to perform a method of controlling a microwave oven, wherein the computer-executable instructions include:
determining whether a plug and play drive storing a plurality of items of cooking information is electrically connected to the microwave oven;
reading out and displaying the stored cooking information if the plug and play drive is connected to the microwave oven;
determining whether one or more items of the displayed cooking information are selected by a user;
displaying a cooking image and a recipe of the selected cooking information if the items of the displayed cooking information are selected;
determining if one of: an execution command key or a storage command key is manipulated; and
carrying out cooking on the basis of the selected cooking information if the execution command key is manipulated, and storing the selected cooking information in an auxiliary memory if the storage command key is manipulated.

21. (NEW) The computer-readable medium as set forth in claim 20, wherein the plug and play drive is one of: a Universal Serial Bus (USB) drive, a drive in accordance with an IEEE 1394 standard, and a drive in accordance with a Universal Plug and Play standard.
